(19) United States
(12) Patent Application Publication
(10) Pub. No.: US 2010/0293126 A1
(43) Pub. Date: Nov. 18, 2010

(54) AUTOMATED JOB APPLICATION SYSTEM INCLUDING APPLICANT HINTS

(75) Inventors: Nancy Valerie Lang, Palatine, IL (US); Mary E.G. Bear, Burlingame, CA (US); Amy Wilson, Oakland, CA (US); Ravi Banda, Fremont, CA (US); Kerry Hodder, Clontarf (AU); Kathi Lynn Chenoweth, Schererville, IN (US); Andrew Philip Gilliibrand, Yateley (GB); Sally Baggett, Healdsburg, CA (US)

Correspondence Address: Trellis IP Law Group/Oracle, 1900 Embarcadero Road, Suite 109, Palo Alto, CA, 94303, US

(73) Assignee: Oracle International Corporation, Redwood Shores, CA (US)

(21) Appl. No.: 12/465,509

(22) Filed: May 13, 2009

(51) Int. Cl. G06N 5/02

(52) U.S. Cl. 706/46

(57) ABSTRACT

An automated job application system includes a processor coupled to a display and to a user input device, wherein the automated job application system executes one or more instructions for accepting signals from the user input device to determine responses to questions in a job application; comparing the responses to predetermined conditions; determining that one condition is not met; displaying on the display a notification that the condition is not met; and accepting a signal from a user input device to modify a response to the condition so that the condition is met. In a more specific embodiment, the instructions facilitate displaying the notification that the condition is not met via a hint list. The hint list may provide a plurality of conditions that are not met. The conditions may be required or desired and not required, and an indication may be displayed indicative of which required or desired conditions have been met by the applicant.

### BACKGROUND

Computer systems are used to allow job applicants to fill out job application forms, answer questions related to a job position, or to perform other tasks related to hiring a person for a job. Such systems may operate, for example, over the Internet by using a web browser to access pages where forms or questions are provided to an applicant. Another type of job application system is a standalone application that executes on a device local to a user, such as a software application running on a user's personal computer, laptop, personal digital assistant (PDA), cell phone, television set-top box, etc.

One typical property of automated job application systems is that an employer sets conditions or criteria which, if not met, or if only partially met, may result in the applicant being automatically filtered, or disqualified from being considered for the position. For example, if an application system asks the applicant to state whether they speak additional languages other than English, and the applicant answers “no,” then the applicant could be automatically disqualified from further consideration if one of the “essential” conditions for the job is that the applicant speaks Japanese. However, it may have been the case that the applicant speaks some Japanese, and that would have allowed the applicant's file to be sent to the next level of consideration (e.g., sent to a human resources person for further review). In such a case, since the prospective employer had set a rule of requiring some Japanese language speaking ability, but since the applicant did not know that such a requirement was critical to the job application, the result could be that the applicant did not fill out the form properly or answer the automated questions in a manner that would have resulted in an acceptable match for the job, or at least have allowed the applicant's application to proceed to the next level of consideration.

### SUMMARY

An example automated job application system includes a processor coupled to a display and to a user input device. The automated job application system executes one or more instructions for accepting signals from the user input device to determine responses to questions in a job application; comparing the responses to predetermined conditions; determining that one condition is not met; displaying on the display a notification that the condition is not met; and accepting a signal from a user input device to modify a response to the condition so that the condition is met.

In a more specific embodiment, the instructions facilitate displaying the notification that the condition is not met via a hint list. The hint list may provide a plurality of conditions that are not met. The conditions may be required or desired and not required, and an indication may be displayed indicating which required or desired conditions have been met by the applicant.

After providing interactive feedback to the applicant during an online application process, the system of the present embodiment provides the applicant additional opportunity to supply more information or different information based on what is required or desired for a given job and based on what the candidate has already entered. Hence, the system guides the applicant to facilitate capturing pertinent information by providing feedback to the applicant indicative of how their application entries match with the job parameters or criteria, and by accepting additional user input or modifications to the application. The interaction between the applicant and the system may occur as the applicant is completing the application in real time and/or during an application-review stage.

In an alternative embodiment, the system provides feedback to the applicant, wherein the feedback indicates how qualified an applicant is for another job not currently being applied for.

The novel design of certain example systems and methods discussed herein and more fully below may facilitate providing guidance to a candidate or applicant, also called the user herein, as the candidate is completing a job application, or after the candidate has completed a draft of the job application. By selectively providing feedback to the applicant, certain example systems discussed herein may obtain more thorough or complete information from the applicant that is relevant to the particular job. Such feedback to the applicant may facilitate more closely approximating an interview process with an actual interviewer, thereby resulting in a closer fit between the resulting completed application and the job criteria. The system feedback to the applicant may provide the applicant with key insight as to the importance of certain information, such as certain qualifications, work experience, and so on, for a particular job, thereby providing the applicant a sense for the probability that they will get the job or otherwise pass to the next stage in the recruiting process based on the provided information.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram of an automated job application system according to a first embodiment.

FIG. 2 is a flow diagram of a first method adapted for use with the job application system of FIG. 1.

FIG. 3 is an example display interface that may be displayed via the client-side interface of FIG. 1.

FIG. 4 is a flow diagram of a second method adapted for use with the job application system of FIG. 1 and the display interface of FIG. 3.

### DETAILED DESCRIPTION OF EMBODIMENTS

Although the description has been described with respect to particular embodiments thereof, these particular embodiments are merely illustrative, and not restrictive. For example, although various embodiments are discussed herein with respect to an online application process implemented via one or more servers and one or more clients, embodiments are not limited thereto. For example, various embodiments disclosed herein may reside on a single computer without departing from the scope of the present teachings.

For clarity, certain well-known components, such as the Internet, Internet Service Providers (ISPs), firewalls, power supplies, and so on, have been omitted from the figures. However, those skilled in the art with access to the present teachings will know which components to implement and how to implement them to meet the needs of a given application.

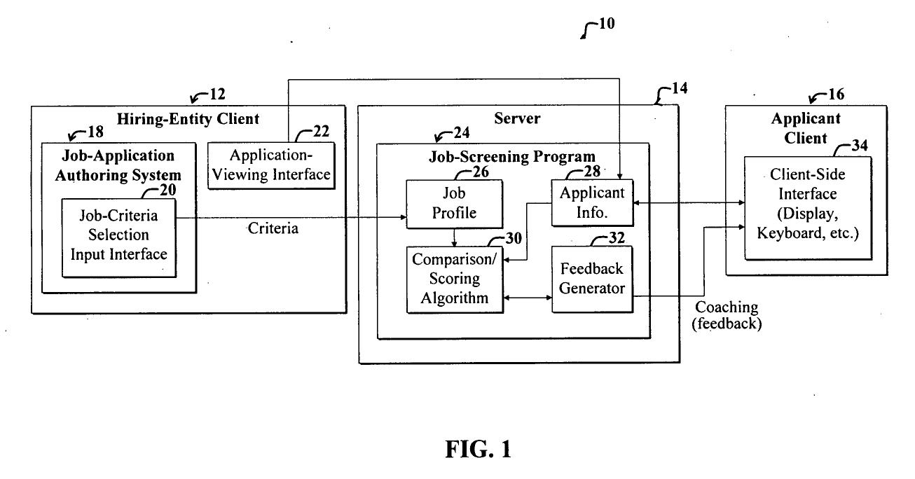

FIG. 1 is a diagram of an automated job application system 10 according to a first embodiment. The system includes a hiring-entity (e.g., employer) client 12 in communication with a server 14. An applicant client 16 communicates with the server 14, which may be coupled to the Internet or other network. The hiring-entity client 12 includes an application-viewing interface 22 and a job-application authoring system 12, which includes a job-criteria selection input interface 20.

The server 14 includes a job-screening program 24, which includes instructions for facilitating creating a job profile 26 based on job criteria received from the job-criteria selection input interface 20. The job-screening program 24 further includes memory for storing job application information 28, and a comparison/scoring algorithm 30 for comparing entered job application information 28 with the job profile 26. A feedback generator 32 is coupled to the comparison/scoring algorithm 30 and is adapted to provide information or feedback to a client-side interface 34 running on the applicant client 16. The job application information 28 may be entered via the client-side interface 34, which an applicant may use to complete an online application generated via instructions running on the job-screening program 24. Note that while the job application is discussed herein as being generated via a server-side application, a client-side application may be employed without departing from the scope of the present teachings.

In operation, a hiring entity, such as an employer, or other entity providing a job application or implementing a hiring process (also called the author herein), may determine certain criteria associated with a job. These criteria may be entered via the job-criteria selection input interface 20, which may include a display, keyboard, mouse, and/or other suitable input devices. Each criterion for a job may be assigned a certain level of importance, e.g., required, not required, desired, and so on. The job-screening program 24 may then employ the criteria to generate an online application to be completed by a user of the applicant client 16.

For the purposes of the present discussion, required job criteria may be any characteristics of a prospective applicant that are required for a given job. Similarly, desired criteria may be any characteristics (or corresponding descriptions thereof) of a prospective applicant that are desired or preferred by an employer for a given job, but the desired criteria may not necessarily represent required criteria.

When establishing certain job criteria, the author may specify one or more predetermined employer job priorities, preferences, or requirements. For the purposes of the present discussion, an employer job priority may be any characteristic of an applicant or application thereof that the employer values for a given job. The exact value that the employer or author assigns to a given characteristic may be application-specific, and may be implemented via assigned numerical values or other applicable techniques. For example, the job-criteria selection input interface 20 may include a slider associated with each criterion, whereby the author may move the slider to one end to specify that the criterion is required, and the author may move the slider to the other end to specify that the criterion is not required. Positioning the slider between opposite ends may provide a relative indication as to the importance of the criterion for the job-selection process. A scoring formula or method may be implemented, such as via the comparison/scoring algorithm 30, whereby the degree to which entered applicant information 28 matches criteria stored in the job profile 26 is indicated by a score.

Similarly, an employer job preference may indicate which characteristic or qualification is more desirable than another characteristic or qualification of an applicant or application thereof. Furthermore, an employer requirement may be any characteristic of an applicant or application thereof that is required by the employer for a given job. An employer requirement represents a required criterion. Employer priorities, preferences, or requirements may represent job criteria, which may be determined or established via an employer or other author using the job-criteria selection input interface 20 of FIG. 1.

After the author establishes predetermined job-selection criteria via the job-criteria selection interface 20 and further establishes relative importance of various criteria for the job-selection process, the resulting information is stored in the job profile 26. The job-screen application 24 generates a corresponding online application accessible via the client-side interface 34.

As the applicant completes the online application, corresponding applicant input is stored as applicant information 28, which is accessible via the comparison/scoring algorithm 30. In the present specific embodiment, after the applicant has completed a draft of the job application (also called the preliminary application), the applicant is given an opportunity to review the application at a review stage.

During the review stage, applicant information 28 corresponding to applicant input to the preliminary application is compared to the job criteria as provided via the job profile 26, and a score or other comparison information is generated in response thereto. The comparison information may include information indicating which criteria are required or desired for the job and whether the applicant information 28 satisfies the criteria or does not satisfy the criteria.

The feedback generator 32 may employ the comparison information to generate a hint list or other feedback to be provided to the applicant via the client-side interface 34. For example, the comparison information may indicate that the applicant has indicated that he does not speak Japanese, but that Japanese-speaking ability is required for the job being applied for. The feedback generator 32 may display a pop-up window via the client-side interface 34 indicating that the applicant has not met the criteria for the job as indicated by information entered by the applicant.

The feedback provided to the applicant via the feedback generator 32 may be considered a type of “coaching” to inform the applicant as to what is required for the job and to provide the applicant an opportunity to elaborate or modify application entries.

In the present example embodiment, a completed application may be viewed by the employer or author via the application-viewing interface 22.

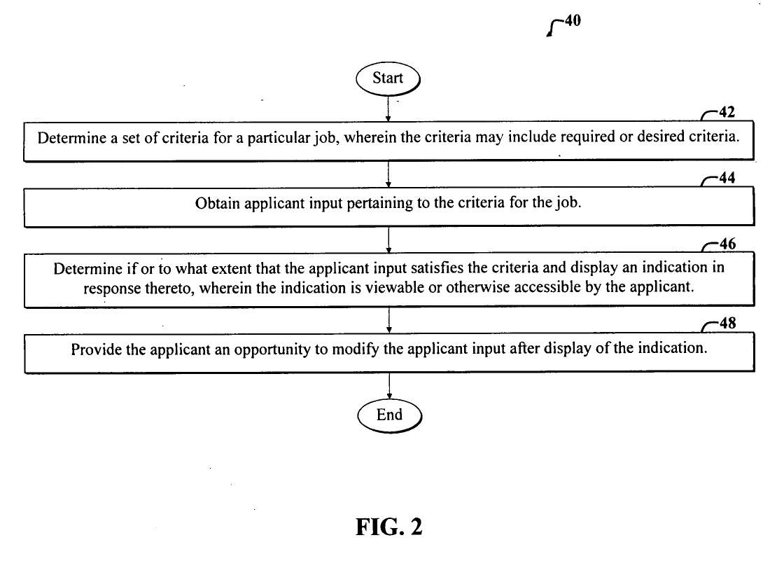

FIG. 2 is a flow diagram of a first method 40 adapted for use with the job application system 10 of FIG. 1. The first method 40 includes a first step 42, which includes determining a set of criteria for a particular job, wherein the criteria may include required or desired criteria.

A second step 44 includes obtaining obtain applicant input pertaining to the criteria for the job. The applicant input may be obtained via an electronic job application, which may be accessible via the Internet or other network and a client with a suitable browser.

A third step 46 includes determining if or to what extent that the applicant input satisfies the criteria and displaying an indication in response thereto. The indication may be viewable or otherwise accessible by the applicant.

A fourth step 48 includes providing the applicant an opportunity to modify the applicant input after display of the indication.

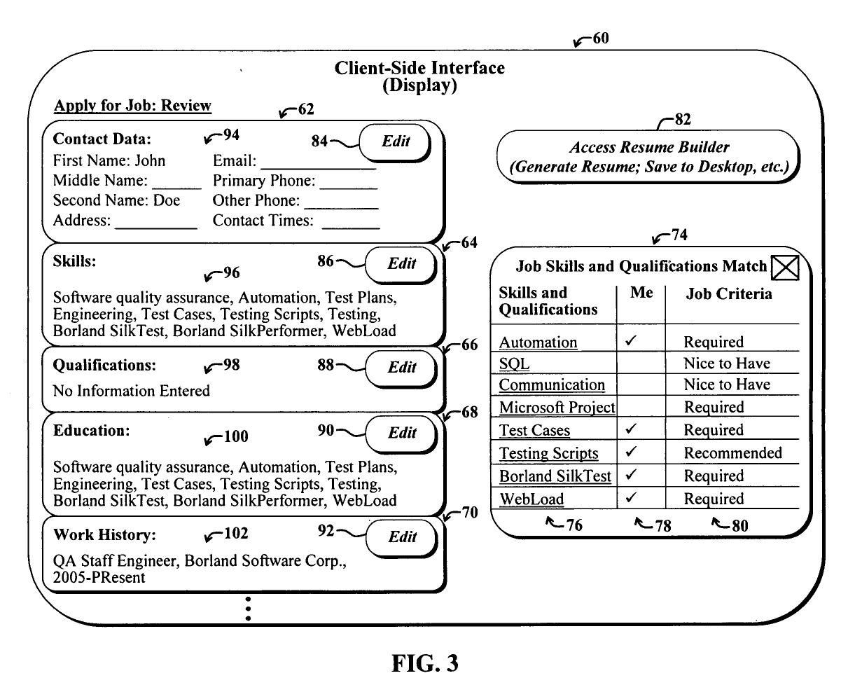

FIG. 3 is an example display interface 60 that may be displayed via the client-side interface 34 of FIG. 1. The display interface 60 illustrates a review stage of an application process after an applicant (John Doe) has completed a draft of an online application.

In the present example, at the review stage, entered information is grouped in a contact-data section 62, a skills section 64, a qualification section 66, an education section 68, and a work-history section 72. The contact-data section 62 includes entered contact information 94. The skills section 64 includes entered skill information 96. The qualifications section 98 includes any qualification-information 98. The education section 68 includes entered education information 100. The work history section 72 includes a description of work history 102, and so on. Each section 62-70 may be edited by selecting corresponding edit buttons 84-92, which may enable access to corresponding sections of the online application.

An access-resume-builder button 82 may activate instructions running on the job-screening program 24 of FIG. 1 to enable generating, printing, and saving of a job application entered via the client-side interface 34 of FIG. 1.

In the present example embodiment, a job-skills and qualifications-match pop-up window 74 is displayed. The pop-up window 74 displays feedback as provided to the client-side interface 34 via the feedback generator 32 of FIG. 1.

The pop-up window 74 includes a table, also called a hint-list, which includes a skills-and-qualifications column 76, criterion-met column 78, and a job-criterion-importance column 80. The skills- and qualifications column 76 identifies skills and qualifications, which correspond to predetermined job criteria as entered by the author via the job-criteria selection input interface 20 of FIG. 1. The criterion-met column 78 provides an indication, such as a check or lack of a check, next to each criterion listed in the skills and qualifications column 76. The corresponding importance of each criterion is displayed in the adjacent job-criterion-importance column 80.

The pop-up window 74 provides a convenient way to display various criteria and their importance for a particular job and whether the applicant has entered information that satisfies the given criteria. A user may view the pop-up window and determine where their application is deficient and may optionally provide additional information or edit corresponding sections of the application, e.g., sections corresponding to the sections 62-70 of FIG. 3.

To edit a particular application entry corresponding to a particular job criterion, a user may select the corresponding hyperlinked word in the skills and qualifications column 76. For example, if the user has Microsoft Project skills but has forgot to enter this or has otherwise overlooked this entry or would like to further elaborate on his Microsoft Project skills, the user may select the Microsoft Project link. Selection of the Microsoft Project hyperlink may result in a display of one or more fields whereby the applicant may enter additional formation and/or may correct or augment previously entered information.

Feedback, such as that provided via the pop-up window 74, may facilitate gathering job-specific information by providing guidance to the applicant and enabling the applicant to more closely or accurately fit data entered in their application with criteria required or desired for a given job. The feedback may facilitate sharing information about employer job priorities, preferences, or requirements with the applicant as the applicant completes an online application. This may save time, for example, by reducing the need for an interviewer to request that an applicant return to the application to complete more information. Furthermore, such interactive feedback may more closely model an actual interview process, thereby obtaining a better fit between applicant data and criteria required or desired for a given job.

While the feedback to the applicant is shown displayed via a pop-up window 74 at the review stage of an application-completion process, other mechanisms may be employed at different points in the application process without departing from the scope of the present teachings. For example, each individual skill and qualification may have a separate pop-up window that displays immediately after a user completes a corresponding portion of an application rather than (or in addition to) at the review stage for the entire application.

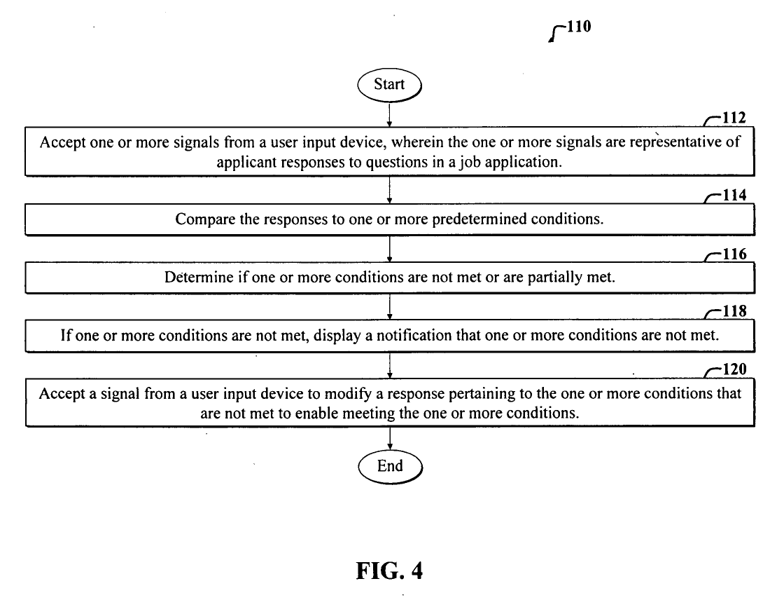

FIG. 4 is a flow diagram of a second method 110 adapted for use with the job application system 10 of FIG. 1 and the display interface 60 of FIG. 3. The method 110 includes an initial information-accepting step 112, which includes accepting one or more signals from a user input device, wherein the one or more signals are representative of applicant responses to questions in a job application.

A subsequent comparing step 114 includes comparing the responses to one or more predetermined conditions, also called criteria.

Next, a determining step 116 includes determining if one or more conditions are not met or are partially met.

A subsequent notification step 118 includes displaying a notification that one or more conditions are not met if one or more of the conditions are not met.

Finally, the method 110 includes a modification step 120, which includes accepting a signal from a user input device to modify a response pertaining to the one or more conditions that are not met to enable meeting the one or more conditions.

The present invention has been described herein with reference to a particular embodiment for a particular application. Those having ordinary skill in the art and access to the present teachings will recognize additional modifications, applications, and embodiments within the scope thereof.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for screening a job applicant in an automated job application system, wherein the automated job application system includes a processor coupled to a display and to a user input device, the method comprising:
accepting signals from the user input device to determine responses to questions in a job application;
comparing the responses to predetermined conditions;
determining that one condition is not met;
displaying on the display a notification that the condition is not met; and
accepting a signal from a user input device to modify a response to the condition so that the condition is met.

2. The method of claim 1, further comprising:
displaying the notification that the condition is not met in a hint list, wherein the hint list includes a plurality of conditions that are not met.

3. The method of claim 2, further comprising:
providing an indication of the degree to which conditions are not met in the hint list.

4. The method of claim 3, further comprising:
displaying a status of one or more of the following in association with each condition that is not met: “required,” “nice to have” or “recommended.”

5. The method of claim 2, wherein the hint list includes a table having rows and columns, the method further comprising:
displaying a column of skill names and a column of requirements, wherein a row of the table includes a skill in association with a requirement.

6. The method of claim 2, wherein the hint list is displayed as a pop-up window overlaying a screen display of the job application system.

7. The method of claim 1, wherein the predetermined conditions are input by an employer or other user via a job-criteria selection input interface.

8. The method of claim 1, wherein the notification is displayed when a response is determined.

9. The method of claim 1, wherein the notification is displayed when an application has been completed.

10. A method for facilitating completion of an application, the method comprising:
providing an online application with fields corresponding to one or more predetermined job criteria;
accepting user input pertaining to the fields; and
comparing the user input to the one or more job criteria and displaying a result in response thereto to a user applying for a job.

11. The method of claim 10, further including providing a user option
to edit the user input after displaying the result.

12. The method of claim 11, wherein the one or more job criteria
include one or more predetermined employer job priorities, preferences, or requirements.

13. The method of claim 11, wherein displaying a result includes providing feedback to the user, wherein the feedback indicates whether the
user has met or not satisfied one or more of the predetermined job priorities, preferences, or requirements.

14. The method of claim 11, wherein displaying a result further
includes displaying a pop-up window indicating which of the one or more criteria are required, nice to have, or recommended, and further indicating whether the user has satisfied the one or more corresponding criteria.

15. A interactive job-applicant screening system comprising:
first means for establishing a set of criteria for a particular job, wherein the criteria may include required or desired criteria;
second means for obtaining applicant input pertaining to the criteria for the job;
third means for determining to what extent the applicant input satisfies the criteria and displaying an indication in response thereto, wherein the indication is viewable or otherwise accessible by the applicant; and
fourth means for providing the applicant an opportunity to modify the applicant input after display of the indication.

16. An apparatus comprising:
one or more processors; and
logic encoded in one or more tangible media for execution by the one or more processors and when executed operable to facilitate completion of a job application by:
providing an online application with fields corresponding to one or more predetermined employer job criteria;
accepting applicant input pertaining to the fields; and
providing information about employer job criteria to an applicant based on the applicant input and the predetermined employer job criteria.

17. The apparatus of claim 16, wherein the logic when executed is further
operable to enable the applicant to modify the applicant input after providing the information.

18. The apparatus of claim 17, further including software encoded in one or more computer-readable media for execution by the one or more processors and when executed operable to display a pop-up window viewable to the applicant, wherein the pop-up window indicates which job criteria the applicant has satisfied and which job criteria is/are required or desired by an employer.

19. A method for facilitating completion of an application, the method comprising:
providing an online application with fields corresponding to one or more predetermined job criteria;
accepting applicant input pertaining to the fields;
estimating an applicant's match to a job by comparing the applicant input to a predetermined job profile and providing a signal in response thereto; and
enabling a user to modify the application information in response to the signal, wherein the signal includes information displayed on a terminal viewable by the user.
